(19) United States
(12) Patent Application Publication
(10) Pub. No.: US 2025/0051679 A1
(43) Pub. Date: Feb. 13, 2025

(54) RECIPROCATING COMPRESSOR LUBRICANTS

(71) Applicant: The Lubrizol Corporation, Wickliffe, OH (US)

(72) Inventors: BRIDGETT RAKESTRAW; SCOTT MILLER

(21) Appl. No.: 18/718,160

(22) PCT Filed: Dec. 6, 2022
(86) PCT No.: PCT/US2022/051913

§ 371 Date: Jun. 10, 2024

Related U.S. Application Data
(60) Provisional application No. 63/288,006, filed on Dec. 10, 2021.

(51) Int. Cl. C10M 169/04; C09K 5/04; C10M 105/38; C10M 133/44; C10M 137/10; C10M 141/10; C10N 30/06; C10N 30/12; C10N 30/14; C10N 30/18; C10N 40/30; F25B 31/02

(52) U.S. Cl. CPC C10M 169/04; C09K 5/045; C10M 105/38; C10M 133/44; C10M 137/105; C10M 141/10; F25B 31/023; C09K 2205/122; C09K 2205/126; C09K 2205/22; C09K 2205/24; C09K 2205/34; C10M 2207/2835; C10M 2215/30; C10M 2223/041; C10M 2223/047; C10N 2030/06; C10N 2030/12; C10N 2030/14; C10N 2030/18; C10N 2040/30

(57) ABSTRACT

Refrigeration lubricants with at least one thiophosphorus additive for use in hydrofluorocarbon refrigeration systems. The thiophosphorus additives may improve the stability and metals and/or refrigerant compatibility of the refrigeration lubricant.

### FIELD OF THE INVENTION

The disclosed technology relates to lubricants for use in reciprocating compressor systems, wherein the refrigerant comprises a hydrofluorocarbon (“HFC”) refrigerant.

### BACKGROUND OF THE INVENTION

Lubricants for use in low back pressure/low temperature conditions have suc-cessfully utilized a combination of corrosion inhibitors or metal deactivators with antioxidants to suppress the oxidation and corrosivity of lubricant refrigerant combinations in reciprocating compressors. In medium back pressure/medium temperature reciprocating compressors, which have an operating envelope wherein the condensing temperatures range from 100-140° F. (37.8-60.0° C.) and evaporating temperatures range from 5-55° F. (−15-12.8° C.), the same lubricants are not a stable, which can result in an increase in acid number and/or darkening of the lubricant. An increase in acid number of the lubricant can result in degradation (deposits, oxidation, and/or corrosion) of compressor metal components, including components made of steel, aluminum, or copper. This situation can be exacerbated in copper systems when sulfur-containing additives are used in the lubricant as it is known that sulfur can contribute to copper corrosion. Therefore, prior to the present technology, metal passivators containing sulfur were avoided in refrigeration systems with copper components.

### SUMMARY OF THE INVENTION

The disclosed technology provides for lubricants that have improved stability in high pressure/high temperature environments, which can result in reduced degradation of compressor metal components. Accordingly, a refrigeration lubricant comprising at least one oil of lubricating viscosity that is an oxygenate and at least one thiophosphorus additive is disclosed. Despite having sulfur, these thiophosphorus additives are surpris-ingly effective at reducing metal corrosion, including copper corrosion, as compared to refrigeration lubricants with metal passivators containing sulfur, for example dimercap-tothidiazole.

The at least one thiophosphorus additive may be a thiophosphorus containing acid, salt, ester, or combinations thereof. Suitable examples of the thiophosphorus esters include, but are not limited to, alkyl-substituted thiophosphorus acid esters, such as a dialkyl dithiophosphoric acid ester. Suitable examples of the thiophosphorus salts include, but are not limited to, alkyl-substituted thiophosphoric acid salts, such as an alkyl-substituted thiophosphate, for example triphenylthiophosphate. In some embodiments, the at least one thiophosphorus additive may comprise dialkyl dithiophosphoric acid ester and/or triphenylthiophosphate (0,0,0-triphenyl phosphorothioate). The at least one thiophosphorus additive may be present at 0.1 to 2 wt %, based on a total weight of the refrigeration lubricant.

The refrigeration lubricant disclosed herein may further comprise at least one phosphorous antiwear additive. Suitable phosphorous antiwear additives include, but are not limited to, alkenyl phosphite, butylated triphenyl phosphate, tricresyl phosphate, dimethyl octadecyl phosphonate, or combinations thereof. The at least one phosphorous antiwear additive may be present at 0.1 to 4 wt %, based on a total weight of the refrigeration lubricant.

In some embodiments, the refrigeration lubricant further may further at least one metal passivator and/or at least one corrosion inhibitor, for example dimercaptothiadiazole and/or benzotriazole. The refrigeration lubricant of claim 10, wherein the at least one metal passivator and/or at least one corrosion inhibitor is substantially free of sulfur, for example, benzotriazole.

In yet other embodiments, the refrigeration lubricant may further comprise at at least one other additive that is a defoamer, an antioxidant, an acid scavenger, or combinations thereof. Suitable defoamers include polydimethyl siloxane. Suitable antioxidants include alkylated ester phenols, alkaryl amines, ditertbutyl cresol, or combinations thereof. Suitable acid scavengers include epoxides.

The defoamer, if present, may be present at 0.01 to 0.5 wt %, based on a total weight of the refrigeration lubricant. The antioxidant, if present, may be present at 0.05 to 1 wt %, based on a total weight of the refrigeration lubricant.

Oxygenates suitable for use in the refrigeration lubricant include at least one alcohol, ester oil, ether oil, or combinations thereof. In some embodiments, the oxygenate may comprise at least one polyol ester, at least one polyalkylene glycol, or combinations thereof. In yet other embodiments, the oxygenate may comprise at least one polyol ester, for example a polyol ester derived from the reaction mixture of neopentyl glycol, pentaerythritol, and 2-ethyl hexanoic acid.

The lubricant compositions described above may be used in combination with a hydrofluorocarbon (“HFC”) refrigerant. Accordingly, compositions are disclosed comprising the refrigeration lubricant as described above and at least one hydrofluorocarbon (“HFC”) refrigerant. Suitable HFC refrigerants include, but are not limited to, R32, R-134a, R-404A, R-410A, or combinations thereof.

Such compositions comprising the refrigeration lubricant and HFC refrigerant are suitable for use in a refrigeration system comprising a compressor and a condenser. The compressor may a reciprocating compressor. In some embodiments, the refrigeration system comprises copper and/or copper alloy components. The disclosed compositions are suitable for use in refrigeration systems wherein the condensing temperatures range from 100-140° F. (37.8-60.0° C.) and evaporating temperatures range from 5-55° F. (−15-12.8° C.).

Methods of improving the metals compatibility and/or reducing metal corrosion of a composition comprising a refrigeration lubricant comprising at least one oil of lubricating viscosity that is an oxygenate by adding least one thiophosphorus additive to the refrigeration lubricant are also disclosed. The composition may further comprise at least one hydrofluorocarbon (“HFC”) refrigerant, for example R-32, R-134a, R-404A, or R-410A. In some embodiments, methods of improving the compatibility and/or stability of a refrigeration lubricant with a hydrofluorocarbon (“HFC”) refrigerant are disclosed. The methods may comprise adding at least one thiophosphorus additive to the refrigeration lubricant.

The use of a thiophosphorus additive in a composition comprising a refrigeration lubricant comprising at least one oil of lubricating viscosity that is an oxygenate to improve the metals compatibility and/or reducing metal corrosion of the composition and/or improve the compatibility and/or stability of the refrigeration lubricant with a hydrofluorocarbon (“HFC”) refrigerant, for example R-32, R-134a, R-404A, or R-410A.

### DETAILED DESCRIPTION OF THE INVENTION

Various preferred features and embodiments will be described below by way of non-limiting illustration. Refrigeration lubricant comprising at least one oil of lubricating viscosity that is an oxygenate and at least one thiophosphorus additive is disclosed. These lubricants have good metals compatibility and/or reduce metal corrosion, including metals containing copper.

### Oxygenate

The refrigeration lubricant comprises an oil of lubricating viscosity that is an oxygenate. As used herein, oxygenate refers to organic compounds containing oxygen as one of their components. These include organic compounds having at least 1 aprotic or protic oxygen for every 6 carbon atoms. Oxygenates also include organic compounds having at least 1 aprotic or protic oxygen for every 7 carbon atoms, or 1 aprotic or protic oxygen for every 8 carbon atoms, or at least 1 aprotic or protic oxygen for every 12 carbon atoms. Oxygenates also include organic compounds having at least 1 aprotic or protic oxygen for every 16 carbon atoms, or 1 aprotic or protic oxygen for every 20 carbon atoms.

Oxygenates can include, for example, alcohols, ester oils and ether oils. The oxygenate may be included in the refrigeration lubricant as the oil of lubricating viscosity from at least 45 wt %, based on a total weight of the refrigeration lubricant. In some instances, the oxygenate may be present from at least 50 wt % to at least 80 wt %. In other embodiments the oxygenate may be present from at least 80 wt % to at least 90 wt %, or at least 95 wt %. In yet other embodiments, the oxygenate may be present from at least 96 wt %, 97 wt %, 98 wt %, or at least 99 wt %, based on the total weight of the lubricant composition.

Alcohols suitable for use as an oil of lubricating viscosity include monohydric alcohols, for example, ethanol, methanol, propylene alcohol derivatives such as n-butanol and tert-butanol, as well as isopropyl alcohol; higher branched alcohols include isomers of pentanol, hexanol, heptanol, octanol, decanol, dodecanol, tetradecanol, hexadecanol and combinations thereof. Examples of branched alcohols include 2-ethylhexanol, iso-octanol, iso-decanol, and isododecanol. Alcohols as used herein also encompass polyols, such as, for example propylene glycol, ethylene glycol, 1,4-butanediol, pentaerythritol, trimethylolpropane.

Ethers suitable for use as an oil of lubricating viscosity include those made from petrochemical feedstocks as well as renewable feedstocks. Examples include methyl tertiary butyl ether (MTBE), tertiary amyl methyl ether (TAME), ethyl tertiary butyl ether (ETBE), and tertiary amyl ethyl ether (TAEE). Other ether examples include tert-hexyl methyl ether (THEME) and diisopropyl ether. Polyethers are also considered herein in the term “ethers,” including, for example, diethylene glycol dibutyl ether. Low molecular weight oligomers of polyalkylene glycols (i.e. polyalkylene oxides) may also be suitable, including polyethylene glycol (PEG), polypropylene glycol (PPG), and mixed polymers thereof.

Ester oils suitable for use as an oil of lubricating viscosity include, for example, esters of monocarboxylic acids with monohydric alcohols; di-esters of diols with mono-carboxylic acids and di-esters of dicarboxylic acids with monohydric alcohols; polyol esters of monocarboxylic acids and polyesters of monohydric alcohols with polycarboxylic acids; and mixtures thereof. Esters may be broadly grouped into two categories: synthetic and natural.

Synthetic esters suitable for use as an oil of lubricating viscosity may comprise esters of monocarboxylic acid (such as acetic acid, propionic acid, neopentanoic acid, 2-ethylhexanoic acid) and dicarboxylic acids (e.g., phthalic acid, succinic acid, alkyl succinic acids and alkenyl succinic acids, maleic acid, azelaic acid, suberic acid, sebacic acid, fumaric acid, adipic acid, linoleic acid dimer, malonic acid, alkyl malonic acids, and alkenyl malonic acids) with any of variety of monohydric alcohols (e.g., butyl alcohol, pentyl alcohol, neopentyl alcohol, hexyl alcohol, octyl alcohol, iso-octyl alcohol, nonyl alcohol, decyl alcohol, isodecyl alcohol, dodecyl alcohol, tetradecyl alcohol, hexadecyl alcohol, 2-ethylhexyl alcohol, ethylene glycol, diethylene glycol monoether, and propylene glycol). Specific examples of these esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, and the complex ester formed by reacting one mole of sebacic acid with two moles of tetraethylene glycol and two moles of 2-ethylhexanoic acid. Other synthetic esters include those made from C₅ to C₁₂ monocarboxylic acids and polyols and polyol ethers such as neopentyl glycol, trimethylolpropane, pentaerythritol, dipentaerythritol, and tripentaerythritol. Esters can also be monoesters of mono-carboxylic acids and monohydric alcohols.

Suitable esters also include esters of hydroxy-substituted carboxylic acids, such as tartaric acid, malic acid, glycolic acid, and hydroxy fatty acids (e.g. 12-hydroxys-tearic acid) in combination with monohydric alcohols as above.

Natural (or bio-derived) esters refer to materials derived from a renewable bi-ological resource, organism, or entity, distinct from materials derived from petroleum or equivalent raw materials. Natural esters suitable in the heat transfer fluids include fatty acid triglycerides, hydrolyzed or partially hydrolyzed triglycerides, or transesterified tri-glyceride esters, such as fatty acid methyl ester (or FAME). Suitable triglycerides include, but are not limited to, palm oil, soybean oil, sunflower oil, rapeseed oil, olive oil, linseed oil, and related materials. Other sources of triglycerides include, but are not limited to, algae, animal tallow, and zooplankton.

In some embodiments, the oil of lubricating viscosity is an oxygenate that comprises at least one polyolester (“POE”) oil, wherein the polyolester oil comprises a polyol esterified with at least one (mono)carboxylic acid that has at least 5 carbon atoms. In yet other embodiments, the polyolester oil comprises a polyol esterified with a mixture of (mono)carboxylic acids or their anhydrides, wherein the (mono)carboxylic acids or anhydrides, individually, have 5 to 13 carbon atoms. Suitable ratios of the C₅ to C₁₃ carboxylic acids or anhydrides include but are not limited to 95:5 to 5:95. In yet other embodiments the mixture of (mono)carboxylic acids or their anhydrides comprises at least three C₅ to C₁₃ carboxylic acid or anhydrides. Suitable polyols include, but are not limited to, trimethylolpropane, dipentaerythritol, neopentylglycol, monopentaerythritol, polypentaerythritol, or combinations thereof. In some embodiments, the POE may comprise esters and/or complex esters of aromatic polycarboxylic acids or their anhydrides. The complex ester may be composed of oligomeric units comprised of polyol (which may include, but is not limited to: trimethylolpropane, dipentaerythritol, neopentylglycol, monopentaerythritol, polypentaerythritol), and polyacid or acid anhydride (which may include, but is not limited to: succinic, glutaric, adipic, citric, trimellitic, pyromellitic), or any mixture thereof. The complex ester may be fully or partially capped with functional (mono)carboxylic acids or (mono)alkylalcohols or singly-capped glycol ethers, or any mixture thereof.

As used herein, “(mono)carboxylic” or “(mono)alkylalcohol”, means the (mono) is optional, i.e. the carboxylic or alkyalochol compounds may be mono or poly. In some embodiments of the disclosed technology, however, only monocarboxylic and/or monoalkylalcohols will be present.

In some embodiments, the oxygenate may comprise an aromatic ester. Suitable aromatic esters are not overly limited. The aromatic hydrocarbon used to make the aromatic ester may have 1 to 5, or 1 to 4, or 2 to 4, carboxylic functional groups. In some embodiments, the aromatic hydrocarbon may be an aromatic carboxylic acid, an aromatic polycarboxylic anhydride, an aromatic polycarboxylic ester, or mixtures thereof. Without limiting the disclosed technology to one theory of operation, it is believed that when the carboxyl group is directly attached to an aromatic ester, the freedom of rotation around that bond is limited. This results in a more rigid molecule with a higher neat viscosity relative to the aromatic esters' molecular weights. In some embodiments, the aromatic ester may be prepared using a polycyclic aromatic acid or acid anhydride, such as 1,8-naphthalic acid.

The (mono)alkylalcohol used to make the aromatic ester may comprise at least one C₄ to C₁₅ or C₈ to C₁₃ linear or branched alcohol. In some embodiments, the (mono)alkylalcohol may comprise a C₁₀ and C₁₃ alcohol. Suitable ratios of the C₁₀ to C₁₃ alcohol include but are not limited to 95:5 to 5:95. In yet other embodiments, the (mono)alkylalcohol may comprises a branched C₁₀ and branched C₁₃ alcohol, i.e. the (mono)alkylalcohol is a mixture of a C₁₀ and C₁₃ alkyl alcohols and both are branched.

The glycol ether used to make the aromatic ester may comprise alkylene glycols, including mono- and poly-ether alcohols with the general structure of: R₁(—O—R₂)ₓ—OR₃, wherein R₁ and R₃ can individually be hydrogen or a C₁ to C₄ hydrocarbyl group; and wherein R₂ can be a monoether or a single, alternating, or randomly distributed pol-yether subunit. Alternatively, the aromatic ester may be a complex ester wherein a doubly uncapped PAG group links two aromatic acids together. In some embodiments, the oxygenate may comprise at least one aromatic ester that is a benzoate ester, phthalate ester, trimellitate ester, pyromellitate ester, or mixtures thereof.

In some instances, the oil of lubricating viscosity is an oxygenate that includes at least one alcohol, ester oil, ether oil, or combinations thereof. In some embodiments, the oxygenate may comprise at least one polyol ester, at least one polyalkylene glycol, or combinations thereof. In yet other embodiments, the oxygenate may comprise at least one polyol ester, for example a polyol ester derived from the reaction mixture of neopentyl glycol, pentaerythritol, and 2-ethyl hexanoic acid.

In other embodiments, refrigeration lubricant may comprise other well-known lubricants instead of, or in addition to, the oxygenates described above. Suitable lubricants can include Groups I-V of the American Petroleum Institute (API) Base Oil Interchange-ability Guidelines, namely

| Base Oil | Sulfur | Saturates | Viscosity |
|---|---|---|---|
| Category | (%) | (%) | Index |
| Group I | >0.03 and/or | <90 | 80 to 120 |
| Group II | ≤0.03 and | ≥90 | 80 to 120 |
| Group III | ≤0.03 and | ≥90 | >120 |

(Groups I, II and III are mineral oil base stocks.)
Group IV All polyalphaolefins (PAOs)
Group V All others not included in Groups I, II, III or IV

The refrigeration lubricant can comprise mineral or synthetic oils e.g., polyal-phaolefin oils and/or polyester oils, and mixtures thereof. In certain embodiments the refrigeration lubricant comprises a mineral oil base stock and may be one or more of Group I, Group II, and Group III base oils or mixtures thereof. In yet other embodiments the refrigeration lubricant may comprise other common base oils, such as alkylbenzene, polyalkylene glycol, and polyvinylether.

### Performance Additives

In some embodiments, the refrigeration lubricant includes at least one thiophosphorus additive as described above. The at least one thiophosphorus additive may be a thiophosphorus containing acid, salt, ester, or combinations thereof. The thiophosphorus additive may have the structure as in formula (I):

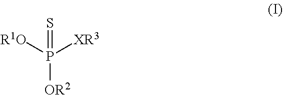

where R¹ and R² may individually be hydrogen or a C₁ to C₂₀ hydrocarbyl group; X may be O or S; and R³ may be hydrogen, a C₁ to C₂₀ hydrocarbyl group, or R⁴(O═C)OR⁵, where R⁴ may be a C₁ to C₈ hydrocarbyl group, and R⁵ may be hydrogen or a C₁ to C₂₀ hydrocarbyl group.

Any of R¹, R², R³, and R⁵ may individually be a linear, branched, or cyclic C₁ to C₂₀ hydrocarbyl group. In some embodiments, any of R¹, R², R³, and R⁵ may individually be a linear, branched, or cyclic C₁ to C₅, C₂ to C₈, or C₄ to C₈, or C₄ to C₆, or C₄ to C₅ hydrocarbyl group. In some instances, R⁴ may be a C₂ to C₆ linear, branched, or cyclic hydrocarbyl group. In some embodiments, R⁴ may be a C₂ hydrocarbyl group or a branched C₃ hydrocarbyl group and/or R⁵ may be a C₁ to C₄ or C₅ hydrocarbyl group.

In some embodiments, the at least one thiophosphorus additive is an alkyl-substituted thiophosphorus acid ester. In such embodiments, the X may be S and R³ may be R⁴(O═C)OR⁵, where R⁴ may be a C₁ to C₈ hydrocarbyl group; R⁵ may be hydrogen or a C₁ to C₂₀, or C₁ to C₄ or C₅ hydrocarbyl group; and R¹ and R² may individually be a linear, branched, or cyclic C₁ to C₂₀, or C₂ to C₈, or C₄ to C₈ hydrocarbyl group. In some embodiments, the at least one thiophosphorus additive may be a dialkyl dithiophosphoric acid ester. In some instances, the dialkyl dithiophosphoric acid ester may have the structure in formula (I) where X may be S and R³ may be R⁴(O═C)OR⁵.

In some instances, the dialkyl dithiophosphoric acid ester may have the structure in formula (II):

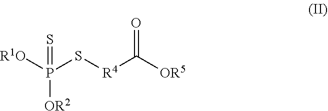

where R¹ and R² may individually be a linear or branched C₁ to C₄ or C₅ hydrocarbyl group; R⁴ may be a C₂ hydrocarbyl group or a branched C₃ hydrocarbyl group; and R⁵ may be a linear or branched C₁ to C₄ or C₅ hydrocarbyl group.

In some embodiments, the at least one thiophosphorus additive may be an al-kyl-substituted thiophosphoric acid salt. In such embodiments, X may be O and R³ may be hydrogen or a C₁ to C₂₀ hydrocarbyl group. In yet other embodiments, X may be O and R¹, R², and R³ may individually be a linear, branched, or cyclic C₁ to C₂₀ or C₂ to C₈ or C₄ to C₈ hydrocarbyl group. In yet other embodiments, X may be O and R¹, R², and R³ may are all cyclic C₅ to C₆ hydrocarbyl groups, for example triphenylthiophosphate (0, O, O-triphenyl phosphorothioate).

In some instances, the refrigeration lubricant comprises at least two thiophosphorus additives, wherein one additive may be a dialkyl dithiophosphoric acid ester and one additive may be triphenylthiophosphate (O, O, O-triphenyl phosphorothioate). The at least one thiophosphorus additive may be present in the refrigeration lubricant at 0.1 to 2 wt %, or 0.2 to 1 wt %, or 0.3 to 0.6 wt %, based on a total weight of the refrigeration lubricant. These various ranges are typically applied to all of the thiophosphorus additives present in the overall composition. However, in some embodiments, these ranges may also be applied to individual thiophosphorus additives.

In some instances, the refrigeration lubricant comprises at least one thiophosphorus additive as described above and at least one antiwear agent. In some instances, the antiwear agent may be a phosphorus antiwear agent. Accordingly, in some embodiments, the refrigeration lubricant includes at least one thiophosphorus additive and at least one phosphorus antiwear agent.

The phosphorus antiwear agent may be a metal-free organo-phosphorus anti-wear agent. The organo-phosphorus antiwear agent may contain sulfur or may be sulfur-free. In some embodiments, the phosphorus antiwear agent may be sulfur-free. The phosphorus antiwear agents may be phosphites, phosphonates, alkylphosphate esters, amine or ammonium phosphate salts, or mixtures thereof.

Phosphorus esters such as the dihydrocarbon and trihydrocarbon phosphites, e.g., dibutyl phosphite, diheptyl phosphite, dicyclohexyl phosphite, pentylphenyl phosphite; dipentylphenyl phosphite, tridecyl phosphite, distearyl phosphite and polypropylene substituted phenol phosphite; amine salts of alkyl and dialkylphosphoric acids or derivatives including, for example, the amine salt of a reaction product of a dialkyldithio-phosphoric acid with propylene oxide and subsequently followed by a further reaction with P₂O₅; and mixtures thereof.

Amine phosphates may be amine salts of (i) monohydrocarbylphosphoric acid, (ii) dihydrocarbylphosphoric acid, (iii) hydroxy-substituted di-ester of phosphoric acid, or (iv) phosphorylated hydroxy-substituted di- or tri-ester of phosphoric acid. The amine salt of phosphorus antiwear agents may be salts of primary amines, secondary amines, tertiary amines, or mixtures thereof.

Amine phosphate salts may be derived from mono- or di-hydrocarbyl phosphoric acid (typically alkyl phosphoric acid), or mixtures thereof. The alkyl of the mono- or di-hydrocarbyl phosphoric acid may comprise linear or branched alkyl groups of 3 to 36 carbon atoms. The hydrocarbyl group of the linear or branched hydrocarbylphosphoric acid may contain 4 to 30, or 8 to 20 carbon atoms. Examples of a suitable hydrocarbyl group of the hydrocarbyl phosphoric acid may include isopropyl, n-butyl, sec-butyl, amyl, 4-methyl-2-pentyl (i.e., methylamyl), n-hexyl, n-heptyl, n-octyl, iso-octyl, 2-ethylhexyl, nonyl, 2-propylheptyl, decyl, dodecyl, tetradecyl, hexadecyl, octadecyl, oleyl, or combinations thereof. In one embodiment, the phosphate is a mixture of mono- and di-(2-ethyl)hexylphosphate.

Examples of suitable primary amines include ethylamine, propylamine, butyl-amine, 2-ethylhexylamine, octylamine, and dodecylamine, as well as such fatty amines as n-octylamine, n-decylamine, n-dodecylamine, n-tetradecylamine, n-hexadecylamine, n-octadecylamine and oleyamine. Other useful fatty amines include commercially available fatty amines such as Armeen™ amines (products available from Akzo Chemicals, Chi-cago, Ill.), such as Armeen C, Armeen O, Armeen O L, Armeen T, Armeen H T, Armeen S and Armeen S D, wherein the letter designation relates to the fatty group, such as coco, oleyl, tallow, or stearyl groups.

Accordingly, in some instances, the refrigeration lubricant comprises at least one phosphorous antiwear additive that is a alkenyl phosphite, butylated triphenyl phosphate, tricresyl phosphate, dimethyl octadecyl phosphonate, or combinations thereof. The metal-free phosphorus anti-wear agent may be present in the lubricant composition in amount of 0.1 to 4 wt %, or 0.1 to 3 wt %, or 0.2 to 1 wt %, or 0.3 to 0.6 wt %.

In yet other embodiments the refrigeration lubricant includes at least one thiophosphorus additive, at least one phosphorus antiwear agent, and at least one metal passivator, wherein the metal passivator may include a corrosion inhibitor and/or a metal deactivator. The metal passivators suitable for use in the refrigeration lubricant are not overly limited and may include both metal deactivators and corrosion inhibitors.

Suitable metal deactivators include triazoles or substituted triazoles. For example, tolyltriazole or tolutriazole may be utilized in the disclosed lubricant composition. Suitable examples of metal deactivator include one or more of:
(i) One or more tolu-triazoles, for example N,N-Bis(2-ethylhexyl)-ar-methyl-1H-benzotriazole-1-methanamine, CAS registration number 94270-86-70, sold commercially by BASF under the trade name Irgamet 39;
(ii) One or more fatty acids derived from animal and/or vegetable sources, and/or the hydrogenated forms of such fatty acids, for example Neo-Fat™ which is commercially available from Akzo Nobel Chemicals, Ltd.

Suitable corrosion inhibitors include one or more of:
(i)N-Methyl-N-(1-oxo-9-octadecenyl)glycine, CAS registration number 110-25-8;
(ii) Phosphoric acid, mono- and diisooctyl esters, reacted with tert-alkyl and (C₁₂-C₁₄) primary amines, CAS registration number 68187-67-7;
(iii) Dodecanoic Acid;
(iv) Triphenyl phosphorothionate, CAS registration number 597-82-0; and
(v) Phosphoric acid, mono- and dihexyl esters, compounds with tetramethylnonyl-amines and C₁₁₋₁₄ alkylamines.

In one embodiment, the metal passivator is comprised of a corrosion additive and a metal deactivator. One useful additive is the N-acyl derivative of sarcosine, such as an N-acyl derivative of sarcosine. One example is N-methyl-N-(1-oxo-9-octadecenyl) glycine. This derivative is available from BASF under the trade name SARKOSYL™ O. Another additive is an imidazoline such as Amine O™ commercially available from Ciba-Geigy.

Accordingly, in some instances, the refrigeration lubricant may have at least one metal passivator comprising a dimercaptothiadiazole, a benzotriazole, or combinations thereof. The metal passivator may be present in the refrigeration lubricant 0.009 to 0.5 wt %, based on a total weight of the lubricant. In some embodiments, the metal passivator may be present 0.01 to 0.5 wt % or 0.01 to 0.3 wt %, or 0.02 to 0.25 wt %, or even 0.02 to 0.07 wt %, based on a total weight of the refrigeration lubricant. These various ranges are typically applied to all of the metal passivator additives present in the overall composition. However, in some embodiments, these ranges may also be applied to individual corrosion inhibitors and/or metal deactivators. The ranges above may also be applied to the combined total of all corrosion inhibitors and metal deactivators present in the overall composition.

In any of these embodiments, the compositions may further include one or more additional performance additives in addition to the additives described above. Suitable examples of performance additives include antioxidants, defoamers, acid catchers, or mixtures thereof.

The antioxidants suitable for use in refrigeration lubricant are not overly limited. Suitable antioxidants include butylated hydroxytoluene (BHT), butylatedhydroxyan-isole (BHA), phenyl-a-naphthylamine (PANA), octylated/butylated diphenylamine, high molecular weight phenolic antioxidants, hindered bis-phenolic antioxidant, di-alpha-to-copherol, di-tertiary butyl phenol.

In some embodiments, the antioxidant includes one or more of:
(i) Hexamethylene bis(3,5-di-tert-butyl-4-hydroxyhydrocinnamate), CAS registration number 35074-77-2, available commercially from BASF;
(ii) N-phenylbenzenamine, reaction products with 2,4,4-trimethylpentene, CAS registration number 68411-46-1, available commercially from BASF;
(iii) Phenyl-a- and/or phenyl-b-naphthylamine, for example N-phenyl-ar-(1,1,3,3-tetramethylbutyl)-1-naphthalenamine, available commercially from BASF;
(iv) Tetrakis[methylene(3,5-di-tert-butyl-4-hydroxyhydrocinnamate)]methane, CAS registration number 6683-19-8;
(v) Thiodiethylenebis (3,5-di-tert-butyl-4-hydroxyhydrocinnamate), CAS registration number 41484-35-9, which is also listed as thiodiethylenebis (3,5-di-tert-butyl-4-hydroxy-hydro-cinnamate) in 21 C.F.R. § 178.3570;
(vi) Butylated hydroxytoluene (BHT);
(vii) Butylated hydroxyanisole (BHA);
(viii) Bis(4-(1,1,3,3-tetramethylbutyl)phenyl)amine, available commercially from BASF; and
(ix) Benzenepropanoic acid, 3,5-bis(1,1-dimethylethyl)-4-hydroxy-, thiodi-2,1-ethanediyl ester, available commercially from BASF.

In one embodiment, the refrigeration lubricant may comprise antioxidants that are alkylated ester phenols, alkaryl amines, ditertbutyl cresol, or combinations thereof. The antioxidants may be present in the refrigerant lubricant from 0.02 wt % to 1 wt % or 2 wt %, or from 0.05 wt % to 1 wt %, or 0.1 to 0.5 wt %, or 0.1 to 0.3 wt %, based on a total weight of the refrigerant lubricant. These various ranges are typically applied to all of the antioxidants present in the overall composition. However, in some embodiments, these ranges may also be applied to individual antioxidants.

In yet other embodiments, the refrigeration lubricant may further comprise at at least one other additive that is a defoamer, an acid scavenger, or combinations thereof.

Defoamers include polysiloxanes, copolymers of ethyl acrylate and 2-ethylhex-ylacrylate and optionally vinyl acetate as well as demulsifiers including fluorinated polysiloxanes, trialkyl phosphates, polyethylene glycols, polyethylene oxides, polypropylene oxides and (ethylene oxide-propylene oxide) polymers. The disclosed technology may also be used with a silicone-containing antifoam agent in combination with a C₅-C₁₇ alcohol. In yet other embodiments, the additional antifoams may include organic silicones such as polydimethyl siloxane, polyethylsiloxane, polydiethylsiloxane, polyacrylates and polymethacry-lates, trimethyl-trifluoro-propylmethyl siloxane and the like. In one embodiment, the defoamer may be polydimethyl siloxane.

Acid scavengers can include alkoxides having an alkyl group of from about 1 to about 12 carbon atoms, or 1 to 10 carbon atoms or 1 to 4 or 6 or 8 carbon atoms. The carbons can be straight chain or branched, saturated or unsaturated. Example alkoxides include methoxides, ethoxides, isopropoxides, and tert-butoxides. In one embodiment, the acid scavengers include epoxides. The metal passivator may be present in the refrigeration lubricant 0.009 to 0.5 wt %, based on a total weight of the lubricant composition. In some embodiments, the metal passivator may be present 0.01 to 0.5 wt % or 0.02 to 0.3 wt %, or 0.05 to 0.25 wt %, or even 0.02 to 0.07 wt %, based on a total weight of the refrigeration lubricant.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:
hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);
substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy);
hetero substituents, that is, substituents which, while having a predominantly hydrocarbon character, in the context of this invention, contain other than carbon in a ring or chain otherwise composed of carbon atoms and encompass substituents as pyridyl, fu-ryl, thienyl and imidazolyl. Heteroatoms include sulfur, oxygen, and nitrogen. In general, no more than two, or no more than one, non-hydrocarbon substituent will be present for every ten carbon atoms in the hydrocarbyl group; alternatively, there may be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

The refrigeration lubricants are useful in refrigeration systems that use hydrofluorocarbon (“HFC”) refrigerants. Examples of HFC refrigerants include, but are not limited to, R-32 (difluoromethane), R-404A (blend of 44 wt % C₂HF₅, 52 wt % C₂H₃F₃, and 4 wt % C₂H₂F₄), R-134a (1,1,1,2-tetrafluoroethane), R-410A (blend of 50 wt % CH₂F₂, and 50 wt % C₂HF₅), or combinations thereof.

Refrigeration systems typically have a compressor and are charged with both the refrigeration lubricant and a refrigerant. In some embodiments, the compressor may be a reciprocating compressor. In some embodiments, the refrigeration system comprises copper and/or copper alloy components. The disclosed compositions are suitable for use in refrigeration systems wherein the condensing temperatures range from 100-140° F. (37.8-60.0° C.) and evaporating temperatures range from 5-55° F. (−15-12.8° C.).

Methods of improving the metals compatibility and/or reducing metal corrosion of a composition are disclosed. The compositions comprise a refrigeration lubricant comprising at least one oil of lubricating viscosity that is an oxygenate. The method may comprise adding least one thiophosphorus additive as described above to the refrigeration lubricant. In some embodiments, the composition may further comprise at least one hydrofluorocarbon (“HFC”) refrigerant, for example R-32, R-134a, R-404A, or R-410A.

Methods and uses of improving the compatibility and/or stability of a refrigeration lubricant with a hydrofluorocarbon (“HFC”) refrigerant are also disclosed. The methods and uses comprise adding at least one thiophosphorus additive to the refrigeration lubricant. Methods and uses of a thiophosphorus additive in a composition comprising a refrigeration lubricant comprising at least one oil of lubricating viscosity that is an oxygenate to improve the metals compatibility and/or reducing metal corrosion of the composition are also disclosed.

The refrigeration lubricants disclosed herein have improved stability and metals and/or refrigerant compatibility, which may be better understood with reference to the following examples.

### EXAMPLES

Multiple lubricant samples were prepared and the lubricants' stability and compatibility with various metals are evaluated.

### Lubricant and R-410A Stability and Compatibility at 175° C.

Five different lubricants are combined with R-410A refrigerant. R-410A is a zeotropic blend of 50 wt % difluoromethane (CH₂F₂, called R-32) and 50 wt % pentaflu-oroethane (CHF₂CF₃, called R-125). The lubricant compositions are provided in Table 1 below:

TABLE 1

| | Comp | Inv | Inv | Inv | Inv |
|---|---|---|---|---|---|
| | Ex | Ex 1 | Ex 2 | Ex 3 | Ex 4 |
| Component | wt % | wt % | wt % | wt % | wt % |
| POE Base Oil | 99.628 | 98.929 | 98.879 | 98.929 | 98.879 |
| Thiophosphorus additive¹ | — | 0.550 | 0.550 | — | — |
| Thiophosphorus additive² | — | — | — | 0.4 | 0.4 |
| Phos antiwear³ | — | — | — | 0.4 | 0.4 |
| MP⁴ (dimercaptothiadiazole) | 0.25 | — | — | — | — |
| MP (benzotriazole) | — | — | 0.05 | — | 0.05 |
| Defoamer | 0.022 | 0.022 | 0.022 | 0.022 | 0.022 |
| AO⁵ (alkylated ester phenol) | 0.10 | — | — | — | — |
| AO (alkaryl amine) | — | 0.25 | 0.25 | — | — |
| AO (ditertbutyl cresol) | — | 0.25 | 0.25 | 0.25 | 0.25 |

¹Thiophosphorus additive is a dithiophosphoric acid ester
²Thiophosphorus additive is a triphenylthiophosphate
³Phosphorous antiwear is a butylated triphenyl phosphate
⁴MP designates a metal passivator
⁵AO designates an antioxidant

For each lubricant, 4 sealed tubes are prepared. The first three tubes contain the refrigerant and lubricant in a ratio of 2 to 8 (0.4 g. of refrigerant to 1.6 g. of lubricant). One metal catalyst (copper, aluminum, or steel) is also placed in each tube. A fourth tube contains more of the lubricant and refrigerant mixture in the same 2 to 8 ratio (0.5 g. refrigerant and 2.0 g. lubricant an a metal catalyst. A visual assessment of both the liquid and metal catalyst is made and recorded. The tubes are then aged at a constant temperature of 175° C. for 14 days. After aging, the first 3 tubes are visually examined for changes in lubricant color, opacity, particulate formulation, corrosion of the metal catalysts and copper plating on the surface of the steel catalyst. The visual results are obtained and recorded.

The color of the lubricant is measured according to ASTM D1500. For this color test, the liquid sample is placed in a test container and compared with colored glass disks using a colorimeter and standard light source. The glass discs range in value from 0.5 to 8.0.

The visual results are described in Table 2 below.

TABLE 2
175° C. Visual Results

| Visual | | | | | | |
|---|---|---|---|---|---|---|
| Observations | | Comp Ex | Inv Ex 1 | Inv Ex 2 | Inv Ex 3 | Inv Ex 4 |
| Liquid (as | unaged | very faint | very faint | very faint | very faint | very faint |
| compared to | | cloudiness; | cloudiness; | cloudiness; | cloudiness | cloudiness |
| unaged | | color = 2.25; | color = 2.25; | color = 2.25; | color = 2.25; | color = 2.25; |
| samples) | | no deposit | no deposit | no deposit | no deposit | no deposit |
| | aged | light | faint | faint | cloudiness | cloudiness |
| | | cloudiness; | cloudiness; | cloudiness; | unchanged; | unchanged; |
| | | Color = 3.0; | color = 2.75; | color = 2.75; | color = 2.5; | color = 2.5; |
| | | no deposit | no deposit | no deposit | no deposit | no deposit |
| Metal | aged | Steel with | Steel became | Steel became | All metals | All metals |
| Coupons | | bluish-green | dull and | dull and | shiny, | shiny, |
| (as compared | | mottled over | charcoal- | charcoal- | unchanged | unchanged |
| to unaged | | brown color; | gray; | gray; | | |
| samples) | | Cu black; Al | Cu and Al | Cu and Al | | |
| | | unchanged | unchanged | unchanged | | |

As can be seen in the visual test results above, the inventive lubricants were closer in color to the unaged samples, indicating less degradation of the lubricant when exposed to 175° C. for 14 days. The color values were 2.75 for Inventive Examples 1 and 2 (Inv 1 and Inv 2) and 2.5 for Inventive Examples 3 and 4 (Inv 3 and Inv 4) versus 3.0 for the Comparative Example (Comp Ex). The inventive lubricants were also more compatible with the metal coupons, particularly for copper. The metal coupons for Inv 3 and Inv 4 remained shiny of all metals, a significant improvement over the comparative lubricant.

The sample tubes are then opened and the lubricants from these tubes degassed. The lubricants are then analyzed for Total Acid Number (“TAN”) (using ASTM D974) and analyzed for decomposition acids (Total Organic Acids) using Ion Chromatography (“IC”). If fluoride is present in the lubricant, it can indicate that incompatibility with the HFC refrigerant. The IC results are shown in Table 3 below.

TABLE 3
175° C. IC Results

| | | Comp | Inv | Inv | Inv | Inv |
|---|---|---|---|---|---|---|
| Test Result | | Ex | Ex 1 | Ex 2 | Ex 3 | Ex 4 |
| TAN (mg KOH/g) | unaged | .195 | 0.04 | 0.06 | 0.02 | 0.04 |
| | aged | 0.06 | 0.38 | 0.42 | 0.04 | 0.04 |
| ppm fluoride | unaged | 0 | 0 | 0 | 0 | 0 |
| | aged | 1 | 1 | 1 | 1 | 0 |
| ppm TOA¹ | unaged | 32 | 36 | 48 | 37 | 46 |
| | aged | 43 | 136 | 143 | 37 | 42 |

¹Total Organic Acids

As shown above, Inv 3 and Inv 4 have a smaller change in TAN after aging than Comp Ex.

### Lubricant and R-32 Stability and Compatibility at 200° C.

Additional samples of Comparative Example (Comp Ex) and Inventive Examples 3 and 4 (Inv 3 and Inv 4) are prepared with R-32 refrigerant. R-32 is difluoromethane (CH₂F₂). The aging tests are also repeated with the samples, except the samples are main-tained at 200° C. for 14 days. The lubricants' performance are also tested using the visual tests and IC tests as described above. The visual results are described in Table 5 below.

TABLE 5
200° C. Visual Results

| Visual | | | | |
|---|---|---|---|---|
| Observations | | Comp Ex | Inv Ex 3 | Inv Ex 4 |
| Liquid | unaged | very faint cloudiness; | very faint cloudiness; | very faint cloudiness; |
| (as compared to | | color = 2.25; | color = 2.25; | color = 2.25; |
| unaged samples) | | no deposit | no deposit | no deposit |
| | aged | Medium white/dark- | faint cloudiness; | faint cloudiness; |
| | | gray cloudiness; | color = 2.75; | color = 2.75; |
| | | small amount of | faint white deposit at | faint white deposit at |
| | | black particulate | bottom of tube | bottom of tube |
| | | throughout; color | | |
| | | two tubes = 3.0; third | | |
| | | tube = 5.0; | | |
| | | medium to heavy | | |
| | | white and dark gray | | |
| | | deposit on tube wall | | |
| | | and bottom | | |
| Metal Coupons | aged | Steel dark black; | Steel light brown; | Steel and Cu slightly |
| (as compared to | | Cu medium black; | Cu slightly dull; | dull; Al unchanged |
| unaged samples) | | Al unchanged | Al unchanged | |

As can be seen in the visual test results above, the inventive lubricants were closer in color to the unaged samples, indicating less degradation of the lubricant when exposed to 200° C. for 14 days. Comp Ex also had dark deposits on the tube wall and bot-tom. The inventive lubricants were also more compatible with the metal coupons, particularly for copper. The IC results are shown in Table 6 below.

TABLE 6
200° C. IC Results

| | | Comp | Inv | Inv |
|---|---|---|---|---|
| Test Result | | Ex | Ex 3 | Ex 4 |
| TAN | unaged | 0.195 | 0.02 | 0.04 |
| (mg KOH · g) | aged | 2.62 | 0.10 | 0.12 |
| ppm fluoride | unaged | 0 | 0 | 0 |
| | aged | 5.5 | 0 | 1 |
| ppm TOA¹ | unaged | 32 | 37 | 46 |
| | aged | 67.5 | 58 | 81 |

¹Total Organic Acids

As shown above, Inv 3 and Inv 4 have a smaller change in TAN after aging at 200° C. than Comp Ex. Inv 3 and Inv 4 are also more compatible with the HFC refrigerant as indicated by the lower concentration of fluoride in the lubricant.

Each of the documents referred to above is incorporated herein by reference, including any prior applications, whether or not specifically listed above, from which pri-ority is claimed. The mention of any document is not an admission that such document qualifies as prior art or constitutes the general knowledge of the skilled person in any jurisdiction. Except in the Examples, or where otherwise explicitly indicated, all numeri-cal quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A refrigeration lubricant comprising at least one oil of lubricating viscosity that is an oxygenate, at least one thiophosphorous additive and at least one phosphorous antiwear additive.
a. wherein the at least one thiophosphorous additive is triphenylthiophosphate; and
b. wherein the at least one phosphorous antiwear additive comprises alkenyl phosphite, butylated triphenyl phosphate, tricresyl phosphate, dimethyl octadecyl phosphate, or combinations thereof.

2. (canceled)

3. (canceled)

4. (canceled)

5. (canceled)

6. The refrigeration lubricant of claim 1, wherein the at least one thiophosphorous additive comprises O, O, O-triphenyl phosphorothioate.

7. The refrigeration lubricant of claim 1, wherein the at least one thiophosphorous additive is present at 0.1 to 2 wt %, based on a total weight of the refrigeration lubricant.

8. (canceled)

9. (canceled)

10. The refrigeration lubricant of claim 1, wherein the at least one phosphorous antiwear additive is present at 0.1 to 4 wt %, based on a total weight of the refrigeration lubricant.

11. The refrigeration lubricant of claim 1, wherein the lubricant further comprises at least one metal passivator and/or at least one corrosion inhibitor, for example dimercaptothiadiazole and/or benzoltriazole.

12. The refrigeration lubricant of claim 11, wherein the at least one metal passivator and/or at least one corrosion inhibitor is present at 0.009 to 0.5 wt %.

13. The refrigeration lubricant of claim 11, wherein the at least one metal passivator and/or at least one corrosion inhibitor is substantially free of sulfur.

14. The refrigeration lubricant of claim 1, further comprising at least one other additive that is a defoamer, an antioxidant, an acid scavenger, or combinations thereof.

15. The refrigeration lubricant of claim 14, wherein the defoamer, if present, is present at 0.01 to 0.5 wt %, based on a total weight of the refrigeration lubricant.

16. The refrigeration lubricant of claim 14, wherein the antioxidant, if present, is present at 0.05 to 1 wt %, based on a total weight of the refrigeration lubricant.

17. The refrigeration lubricant of claim 1, wherein the oxygenate comprises at least one alcohol, ester oil, ether oil, or combinations thereof.

18. The refrigeration lubricant of claim 17, wherein the oxygenate comprises at least one polyol ester, at least one polyalkylene glycol, or combinations thereof.

19. The refrigeration lubricant of claim 18, wherein the oxygenate comprises at least one polyol ester, for example a polyol ester derived from the reaction mixture of neopentyl glycol, pentaerythritol, and 2-ethyl hexanoic acid.

20. A composition comprising the refrigeration lubricant of claim 1 and at least one hydrofluorocarbon (“HFC”) refrigerant.

21. The composition of claim 20, wherein the HFC refrigerant comprises at least one of R-32, R-404A, R-134a, R-410A, or combinations thereof.

22. A refrigeration system comprising a compressor, a condenser, and the composition of claim 20.

23. The refrigeration system of claim 22, wherein the compressor is a reciprocating compressor.

24. The refrigeration system of claim 22, wherein the refrigeration system comprises copper and/or copper alloy components.

25. The refrigeration system of claim 22, wherein the condensing temperatures range from 100-140° F. (37.8-60.0° C.) and evaporating temperatures range from 5-55° F. (−15-12.8° C.).

26. A method of improving the metals compatibility and/or reducing metal corrosion of a composition comprising a refrigeration lubricant comprising at least one oil of lubricating viscosity that is an oxygenate, the method comprising adding least one thiophosphorous additive to the refrigeration lubricant, wherein the at least one thiophosphorous additive is triphenylthiophosphate.

27. The method of claim 26, wherein the composition further comprises at least one hydrofluorocarbon (“HFC”) refrigerant, for example R-32, R-134a, R-404A, or R-410A.

28. A method of improving the compatibility and/or stability of a refrigeration lubricant with a hydrofluorocarbon (“HFC”) refrigerant, the method comprising adding at least one thiophosphorous additive to the refrigeration lubricant, wherein the at least one thiophosphorous additive is triphenylthiophosphate.

29. (canceled)

30. (canceled)

31. (canceled)
